(19) United States
(12) Patent Application Publication
(10) Pub. No.: US 2011/0144866 A1
(43) Pub. Date: Jun. 16, 2011

(54) CONTROL UNIT AND METHOD FOR TRIGGERING PASSENGER PROTECTION MEANS FOR A VEHICLE

(76) Inventor: Ralf Maier, Gerlingen (DE)

(21) Appl. No.: 12/737,733

(22) PCT Filed: Jun. 25, 2009
(86) PCT No.: PCT/EP2009/057950

§ 371 Date: Feb. 11, 2011

(30) Foreign Application Priority Data
Aug. 19, 2008 (DE) 10 2008 041 339.9

(51) Int. Cl. B60R 21/00

(52) U.S. Cl. 701/45

(57) ABSTRACT

In a control unit and a method for triggering passenger protection arrangement for a vehicle, both a test signal from outside an evaluation circuit and a sensor signal from inside the evaluation circuit are made available. The first trigger decision is formed on the basis of the sensor signal. Furthermore, a linking module links the test signal with the sensor signal to form a check signal. The second trigger decision is formed as a function of the check signal. The triggering of the passenger protection arrangement then takes place as a function of the first and the second trigger decisions.

### BACKGROUND OF THE INVENTION

1. Field of the Invention

The present invention relates to a control unit and to a method for triggering passenger protection means.

2. Description of Related Art

From published German patent document DE 10 2004 056 415 A1, an integrated switching circuit is known, which in addition to other functions also evaluates at least one acceleration signal in order to release at least one ignition output stage. This check of the acceleration signals is running parallel to the check of these signals by the microcontroller. This realizes separate evaluation paths. The triggering of the passenger protection means actually takes place only if both the microcontroller and the integrated switching circuit decide on triggering of the passenger-protection means.

### BRIEF SUMMARY OF THE INVENTION

In contrast, the control unit according to the present invention and the method according to the present invention for triggering passenger protection means for a vehicle have the advantage that when the sensor signal is made available via the evaluation circuit, e.g., the microcontroller, this sensor signal is linked to a test signal generated outside of the evaluation circuit in order to generate a check signal, and the check signal is then evaluated by the safety controller, i.e., the redundant evaluation. This prevents that in a situation where the microcontroller is in an uncontrolled state and thus also hands over the sensor signals to the safety controller in an uncontrolled manner, this will be detected based on the linkage with the test signal, which originates from outside the microcontroller, so that an evaluation does not take place and faulty triggering of the passenger protection means is thus prevented.

For instance, the linking of the sensor signals via the evaluation circuit may be provided when so-called bus concepts such as the FlexRay are used for transmitting the sensor signals to the control unit. The microcontroller may then include a receiving circuit for the CAN and/or FlexRay, for instance, so that the full computing power of the microcontroller is able to be utilized in the case at hand and the implementation of a receiver in the second signal path having the safety controller may be dispensed with.

In the present case, a control unit is an electrical device which processes at least one sensor signal and generates trigger signals for the passenger protection means, e.g., airbags, belt tighteners, or a crash-active headrest, as a function thereof. The triggering of the passenger protection means denotes the activation of these passenger protection means.

The test signal generator, which is situated outside of the evaluation circuit but inside the control unit, is used for providing the test signal. This test signal may be called up from a memory such as an EEPROM, or be generated with the aid of predefined data. As can be gathered from the dependent claims, the test signal may be a key or some other coding pattern. As the dependent claims reveal, the test signal generator may be provided on the integrated switching circuit which accommodates all kinds of different functions for the control unit, i.e., a system ASIC. A software-based implementation is possible as well in this case.

As already mentioned, the evaluation circuit may be a microcontroller, but any other type of processor may be used as well. Suitable ASICs are likewise an option. In the case of a processor such as a microcontroller, corresponding software will then be required for the function. According to the present invention, the evaluation circuit has an interface for providing the at least one sensor signal. This interface may be implemented as a software module or also as a hardware section. The interface permits the read-in of the sensor data in order to then allow them to be processed further. The useful data are separated from other transmission data.

The sensor signal is usually a signal from an accident sensor system such as an acceleration sensor, an air-pressure sensor, a structure-borne noise sensor system, or an environment sensor system. However, other sensor systems such as deformation sensor system may be used as well. In the case at hand, the sensor signal and also the other signals are of digital nature, but they may also be transmitted in analog manner. More particularly, the sensor signal may be a multiplex or an individual signal.

The evaluation module according to the present invention may be a software module or also a hardware section on the evaluation circuit. It is used for generating a first trigger decision as a function of the at least one sensor signal. In other words, the evaluation module calculates the evaluation algorithm based on the sensor signal. All kinds of different operations may be performed in the process, including advance processing such as an integration of an acceleration signal with subsequent threshold comparisons, and the like.

The logic module, too, may be implemented in hardware and/or software. It is used for linking the at least one sensor signal with the test signal. This linkage is implemented in such a way that the safety controller or elements assigned to it are able to detect on this basis whether the test signal has been corrupted in some manner by the evaluation circuit. This would then be true for the sensor signal as well.

The safety controller normally is hardware which is separate from the evaluation circuit and forms the second trigger decision as a function of the check signal, independently of the evaluation circuit. In this context it is also possible, for instance, that in the case of a multi-core processor, the evaluation circuit is located on one core, and the safety controller on another core. Usually, the safety controller uses a less complex algorithm than the evaluation module. The check signal also may be preprocessed for the evaluation by the safety controller, e.g., by separating it from the test signal again. This simpler algorithm, which requires fewer computing steps than the evaluation algorithm on the evaluation circuit, may be implemented either in the form of hardware or software.

The trigger circuit is a logic which links the first and second trigger decisions, then evaluates the produced result and triggers the corresponding passenger protection means as a function thereof. One simple example is a logical AND operation. However, the logic may be much more complex in order to also infer from the trigger decisions which particular passenger protection means are to be triggered, and when. The triggering normally takes place by triggering power switches such as MOSFETs, whose triggering then causes the activation of the passenger protection means, e.g., by supplying current to firing elements for airbags.

It is advantageous in this context that the test signal generator is configured to provide a key as the test signal. In other words, the test signal is a key with whose aid encoding is possible as it is known from encryption technology, for instance. This key may be stored permanently, or it may be calculated from predefined data. The test signal generator then has its own memory, or accesses a memory, in which the key is stored, e.g., in the form of a datum.

Furthermore, it is advantageous that the linking module is designed as encoder, the encoder encoding the at least one sensor signal with the key into the check signal, and a safety controller is then assigned a decoder for decoding the check signal. In this case the encoder is a module, which carries out the corresponding calculation, i.e., the encryption or encoding, and the decoder is a corresponding processor which rids the sensor signal of the encryption again. The decoder is not part of the evaluation circuit but part of the system ASIC, for example, as indicated below.

Furthermore, it is advantageous that the interface has a redundancy module, which adds redundancy to the at least one sensor signal and is connected to the linking module accordingly. The at least one sensor signal is then provided with redundancy so that a corresponding correction, for example, may take place. A check sum check may be used for this purpose. The sensor signal thus provided with a check sum is then forwarded for encoding in the linking module, for example.

In addition, it is advantageous that a check module is provided downstream from the decoder, which checks the sensor signal for integrity with the aid of this redundancy, and possibly corrects the sensor signal.

The evaluation circuit may be implemented as processor, as mentioned earlier already. This processor is usually made up of a single semiconductor substrate. The corresponding functions are then realized in silicon on this semiconductor substrate.

The test signal generator, the decoder, the check module and the safety controller as well as the evaluation circuit may advantageously be disposed on a single integrated switching circuit and thus form the system ASIC together with other functions, for example. This enables a cost-effective realization of these functions.

### BRIEF DESCRIPTION OF THE DRAWINGS

FIG. 1 shows a block diagram of the control unit according to the present invention having connected components in the vehicle.

FIG. 2 shows a block diagram of signal processing relevant for the present invention.

FIG. 3 shows a flow chart of the method according to the present invention.

### DETAILED DESCRIPTION OF THE INVENTION

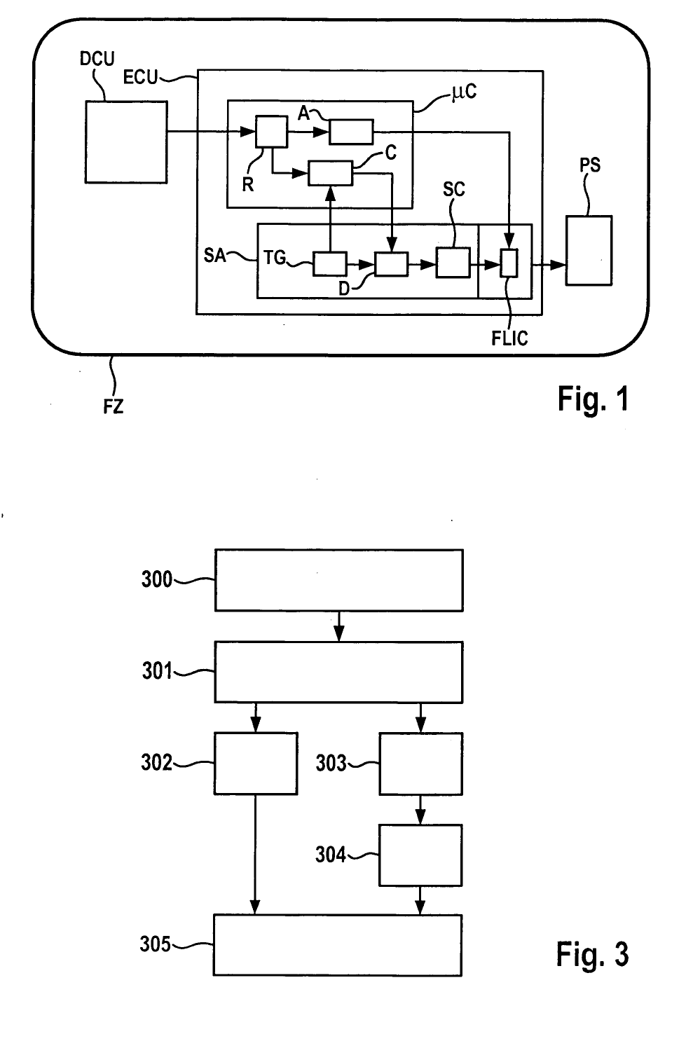

Using a block diagram, FIG. 1 shows control unit ECU according to the present invention in connection with connected devices DCU and PS in vehicle FZ. Here, only the components essential for an understanding of the present invention are illustrated. Other components required for operating control unit ECU have been omitted for the sake of simplicity because they do not contribute to the understanding of the present invention to any essential degree.

A sensor control unit DCU transmits sensor signals or sensor data to control unit ECU, e.g., via a bus, and directly to microcontroller μC in so doing. In the case at hand, the FlexRay standard is used, but it is possible to implement a different standard.

Microcontroller μC itself has an interface R to enable it to receive the sensor data from sensor control unit DCU. This interface R is able to remove the useful data from the transmission frame used for the bus transmission and to forward it to the additional modules in microprocessor μC.

Instead of a sensor control unit DCU, which includes various types of sensors required for the passenger protection function, other structures such as sensor clusters or individual sensors may be provided as well.

The sensor data are forwarded to evaluation module A on the one hand, and to linking module C on the other.

Evaluation module A applies the evaluation algorithm to the sensor signal. Various signal-processing methods are used for this purpose. Threshold value comparisons are implemented, in particular. These threshold values may also be modified as a function of additional variables. If the relevant trigger thresholds are exceeded, then the first trigger decision will be formed by evaluation module A and transmitted to trigger circuit FLIC.

The sensor data are also processed by linking module C, i.e., by linking them to the test signal from test signal generator TG. In the case at hand, this linkage is implemented as encryption or by the simple addition of the key to the sensor signal since the test signal is realized in the form of a key. Linking module C is therefore implemented as encoder. Test signal generator TG is situated in the system ASIC, where a decoder D, safety controller SC and trigger circuit FLIC are disposed as well. Microcontroller μC transmits the encrypted data to decoder D on system ASIC SA via linking module C. Decoder D then checks whether the key is still in the condition in which test signal generator TG had originally transmitted it to encoder C. For this purpose, the key from the test signal generator is provided to decoder D, so that a simple comparison is possible. Decoder D may also receive the key from a memory or some other module.

The useful data are forwarded to safety controller SC, so that the safety controller is able to form the second trigger decision based on this sensor signal. Safety controller SC also carries out at least one threshold value comparison to form the trigger decision, this generation normally being of a simpler nature, i.e., entailing fewer computing steps, than executed by the evaluation algorithm on microcontroller μC.

This trigger decision is then transmitted to trigger circuit FLIC. Trigger circuit FLIC links the two trigger decisions, and the triggering of passenger protection means PS takes place only if both are positive.

Thus, encoder C integrates the key into the signal in order to form the check signal in this manner. The signal may simply be multiplied by the check pattern and then divided in the security path. In general, an unambiguous, reversible mathematical operation is required, i.e., one would search for a variant that is optimal for the propagation time in the signal theory in the realization.

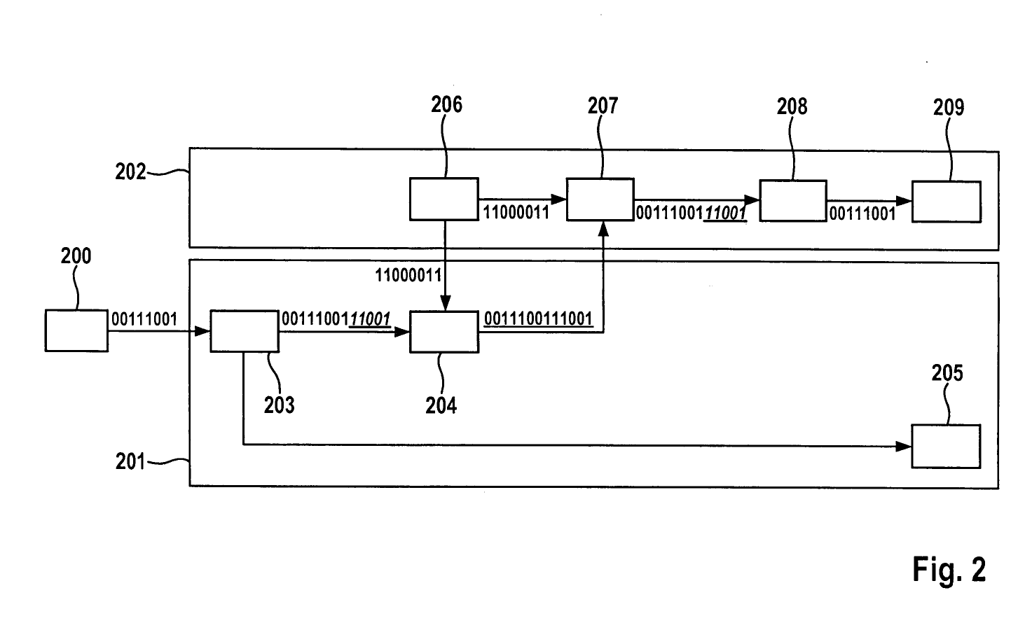

FIG. 2 shows the relevant part of the present invention in the form of a block diagram. Useful data 200 are transmitted to microcontroller 201 in the sequence 00111001 and transmitted to receiver 203, i.e., the interface, in the process. Receiver 203 adds redundancy to the data by adding a check sum, which is generally known as CRC cyclic redundancy code. The data without this check sum are supplied to algorithm 205 so that the first trigger decision can be formed.

The data including the check sum are forwarded to encoder 204, useful data 00111001 being supplemented by the check sum 11001 in the case at hand. Encoder 204 receives key 11000011 from test signal generator 206 on system ASIC 202. Encoder 204 integrates this key into the sensor signal. The signal produced in this manner is transmitted to decoder 207. Decoder 207 is likewise disposed on system ASIC 202. Decoder 207 also receives key 11000011 from test signal generator 206. By separating the key from the transmitted message from encoder 204 again, the decoder is able to infer, by way of by comparison, whether the key has been altered, e.g., by a malfunction of microcontroller 201.

The useful data with the redundancy, obtained through the decoding, are forwarded to a check module 208. This check module uses the redundancy to check whether the useful data were transmitted correctly. If necessary, a correction of the faulty data may take place. If the useful data are not in order, the method will be terminated at this point and no second trigger decision will be made. However, if the useful data are correct or if a correction is able to be implemented, then the useful data are forwarded to safety controller 209, which likewise is disposed on system ASIC 202. There, the second trigger decision may then be formed.

FIG. 3 shows the method according to the present invention in a flow chart. The test signal, e.g., the key, is provided in method step 300. In method step 301, the sensor signal is made available, e.g., via the FlexRay bus in microcontroller μC as the evaluation circuit. In method step 302, the sensor signal is supplied to the evaluation algorithm in order to form the first trigger decision. In method step 303, the linking module uses the sensor signal to form a check signal with the test signal. This may be done with the aid of an encoder. In method step 304, safety controller SC forms the second trigger decision based on this check signal. In method step 305, the first trigger decision and the second trigger decision are linked to each other in order to decide whether or not the passenger protection means should be triggered. Then the triggering of the passenger protection means takes place.

1-10. (canceled)

11. A control unit for triggering a passenger protection arrangement for a vehicle, comprising:
a test signal generator configured to provide a test signal;
an evaluation circuit having:
an interface for providing at least one sensor signal,
an evaluation module configured to generate a first trigger decision as a function of the at least one sensor signal, and
a linking module configured to generate a check signal as a function of a linking of the at least one sensor signal with the test signal;
a safety controller configured to generate a second trigger decision as a function of the check signal; and
a trigger circuit configured to trigger the passenger protection arrangement as a function of the first and second trigger decisions.

12. The control unit as recited in claim 11, wherein the test signal generator is configured to provide a key as the test signal.

13. The control unit as recited in claim 12, wherein the linking module is configured as an encoder encoding the at least one sensor signal and the key into the check signal, and wherein a decoder is assigned to the safety controller to decode the check signal.

14. The control unit as recited in claim 13, wherein the interface has a redundancy module configured to provide redundancy to the at least one sensor signal, and wherein the redundancy module is connected to the linking module.

15. The control unit as recited in claim 14, wherein a check module is connected downstream from the decoder, and wherein the check module is configured to check the sensor signal for integrity based on the redundancy.

16. The control unit as recited in claim 15, wherein the evaluation circuit is implemented as a processor.

17. The control unit as recited in claim 15, wherein the test signal generator, the decoder, the check module, the safety controller and the trigger circuit are disposed on a single integrated switching circuit.

18. A method for triggering a passenger protection arrangement for a vehicle, comprising:
providing a test signal and at least one sensor signal;
generating a first trigger decision as a function of the at least one sensor signal;
generating a check signal as a function of a linkage of the at least one sensor signal with the test signal;
generating a second trigger decision as a function of the check signal; and
triggering the passenger protection arrangement as a function of the first and second trigger decisions.

19. The method as recited in claim 18, wherein a key is provided as the test signal.

20. The method as recited in claim 19, wherein the at least one sensor signal and the key are encoded into the check signal.
